(19) United States
(12) Patent Application Publication
(10) Pub. No.: US 2025/0200329 A1
(43) Pub. Date: Jun. 19, 2025

(54) METHOD AND SYSTEM OF DISTRIBUTED INFERENCE

(71) Applicant: HUAWEI TECHNOLOGIES CO., LTD., Shenzhen (CN)

(72) Inventors: Theodoros Giannakas, Boulogne Billancourt (FR); Apostolos Destounis, Boulogne Billancourt (FR); Dimitrios Tsilimantos, Boulogne Billancourt (FR)

(73) Assignee: HUAWEI TECHNOLOGIES CO., LTD., Shenzhen (CN)

(21) Appl. No.: 19/072,614

(22) Filed: Mar. 6, 2025

Related U.S. Application Data
(63) Continuation of application No. PCT/EP2022/074738, filed on Sep. 6, 2022.

(51) Int. Cl. G06N 3/045; G06N 3/084; G06N 3/09; G06N 3/092

(52) U.S. Cl. CPC G06N 3/045; G06N 3/084; G06N 3/09; G06N 3/092

(57) ABSTRACT

Disclosed are a method and a system of distributed inference. The method comprises: processing a data sample (x) in accordance with a first deep neural network, DNN, inference function (F₀, 21) of a mobile device; initiating a local and/or a remote inference in accordance with a second DNN inference function (F_{C}, 22) of the mobile device; forwarding the processed data sample (z) in accordance with the initiated local and/or remote inference; determining an local exit result (y₁) of the initiated local inference in accordance with a third DNN inference function (F₁, 24) of the mobile device and the processed data sample (z); determining a remote exit result (y₂) of the initiated remote inference in accordance with a fourth DNN inference function (F₂, 31) of the server device and the processed data sample (z); and providing a final result (y_{final}) of the initiated local and/or remote inference.

### CROSS-REFERENCE TO RELATED APPLICATIONS

This application is a continuation of International Application No. PCT/EP2022/074738, filed on Sep. 6, 2022, the disclosure of which is hereby incorporated by reference in its entirety.

### TECHNICAL FIELD

The present disclosure relates generally to the field of machine learning, and to a method and a system of distributed inference via a wireless connection.

### BACKGROUND ART

Machine learning (ML) and deep learning (DL) have led to breakthroughs in various challenging applications such as image classification, computer vision and natural language processing.

However, the deployed DL models that are required to support the ML tasks are usually quite demanding in terms of resources, and large DL models can easily become energy and time consuming. For this reason, the standard practice nowadays is to rely on cloud computing for these services. For instance, when an edge device has to perform an ML task (e.g. inference, prediction) on a data sample, it sends this sample to the cloud server, where it is processed by a large and powerful DL model, whose output is then returned back to the edge device.

An emerging need to perform ML tasks on edge devices that are wirelessly connected to the cloud brings new challenges due to the dynamic nature of the wireless channels and gives rise to the question whether inference should take place on the cloud (remote inference) or on the mobile device (local inference). Local inference on the mobile device accounts for low delay by avoiding the round-trip wireless transmission to the cloud. However, as it is impractical to deploy large models in energy-constrained devices (that would also quickly drain their battery), local inference can suffer from lower prediction accuracy. Remote inference on the cloud server offers the capability for significantly larger DL models, at the cost of higher response delay. This becomes even more important in wireless networks due to the dynamic channel conditions. Not only is the inference time random and potentially large, but the transmission may also prove to be energy consuming if the channel conditions are bad. As both approaches have significant drawbacks, distributed inference wherein a Deep Neural Network (DNN) is split into local layers at the edge device and remote layers at the cloud server emerges as a promising intermediate and flexible approach. An important point is that the device has the capability to provide an output prediction on its own, called local exit.

During inference, with every new data sample x, it has to be decided whether the prediction should be offloaded to the cloud by using the full DNN (both local and remote layers) or if the local hardware is enough to provide a good result at the local exit. If the local exit is chosen, only the local model is executed and the final inference result is the local prediction; no bits are transmitted through the wireless channel to the cloud server, and there is no knowledge of what could have happened if all DNN layers had been used. Otherwise, the sample is first passed through the local layers, then the output of one of its DNN layers is sent to the cloud server through the wireless channel where it is used as input for the DNN layers at the cloud. The remote exit result of the full DNN is returned to the edge device again through the wireless channel.

Despite the flexibility and the practical interest in this setup, there are few key challenges that need to be addressed. First, the DNN should be trained in order to provide good/relevant outputs in all its exits. Both centralized and distributed training can be used, as the device and the cloud server can be located far apart. Second, the edge device needs to make offloading decisions for each sample relying only on its local layers and their outputs. Third, making the offloading decisions must be application-independent, for example, to be able to tackle a variety of tasks. A problem that arises in the distributed DNN setting is that a standard approach to characterize the quality of the local exit (and as a result if remote layers should be used or not) is its uncertainty. Nonetheless, the notion of prediction entropy (proxy for uncertainty that uses the probability masses over the different classes) is applicable to image classification and does not apply to time series—and in general regression—problems.

### SUMMARY

It is an objective to overcome these and other drawbacks.

The foregoing and other objectives are achieved by the features of the independent claims. Further implementation forms are apparent from the dependent claims, the description and the figures.

According to a first aspect, a method of distributed inference is provided, the method comprising: processing a data sample in accordance with a first deep neural network (DNN) inference function of a mobile device; initiating a local and/or a remote inference in accordance with a second DNN inference function of the mobile device; forwarding the processed data sample in accordance with the initiated local and/or remote inference; determining an local exit result of the initiated local inference in accordance with a third DNN inference function of the mobile device and the processed data sample; determining a remote exit result of the initiated remote inference in accordance with a fourth DNN inference function of the server device and the processed data sample; and providing a final result of the initiated local and/or remote inference in accordance with a fifth inference function.

First, in a default energy saving mode, a mobile device receives observations from its environment that help it shape an understanding of its surroundings. These observations are crucial, given that distributed inference involves a wireless communication between the mobile device and a server device that exhibits a random and unpredictable behavior. The mobile device can therefore take actions in a way that balance a prediction accuracy, an experienced latency/delay, and/or a consumed energy. Accordingly, the method of distributed inference resolves the problem of dynamic environment conditions.

Second, in an alternative accuracy mode, more predictions (local and remote) are available and can be combined so that in principle the final prediction is better than the two initial ones. Accordingly, the method of distributed inference may increase a prediction accuracy.

Third, the “offloading” of the mobile device 2 is task-independent. The logic and the overall architecture is able to resolve any given ML task since no problem-specific aspects are used. Accordingly, the method of distributed inference is applicable to a variety of ML problems.

A deep neural network as used herein may refer to an artificial neural network architecture with multiple layers between its input and output layers and being suitable for a broader family of machine learning methods being known as deep learning.

An inference function as used herein may refer to a function for predicting output data samples in accordance with input data samples and based on a model of a relationship between input data samples and output data samples. In connection with DNNs, an inference function may refer to an inference phase of the DNN wherein predictions may be inferred in accordance with input data samples and the DNN-based model of the relationship between input data samples and output data samples. The DNN-based model has typically been acquired in a preceding training phase of the DNN.

Local inference as used herein may refer to invocation of an inference function within an edge device, for example a mobile device, having restrictive limits in terms of processing and energy storage capabilities. A result of local inference may be termed ‘local exit result’.

Remote inference as used herein may refer to invocation of an inference function of a remote device, for example a server device, having less restrictive limits in terms of processing and energy storage capabilities than an edge device. A result of remote inference may be termed ‘remote exit result’.

Distributed inference as used herein may refer to a combination of local inference and remote inference. A result of distributed inference may be termed ‘final exit result’ and depend on the ‘local exit result’ of local inference as well as on the ‘remote exit result’ of remote inference.

In a possible implementation form, initiating the local inference and/or the remote inference may comprise: providing respective indicators for local inference and remote inference as being set, if an indicator for high accuracy (of inference) is set; and providing the respective indicators for local inference and remote inference in accordance with the second DNN inference function, the data sample and a state of an environment of the mobile device, if an indicator for high accuracy is not set.

In a possible implementation form, the data sample may comprise one of: a digital image, and a portion of a time series;

A digital image as used herein may refer to an arrangement of a finite set of digital values (e.g., picture elements or “pixels”) in a fixed number of rows and columns, the digital values respectively representing a brightness of a given color at any specific point (e.g., intersection of a row and a column) within the arrangement.

A time series as used herein may refer to a series of data samples listed in time order.

In a possible implementation form, the state of the environment of the mobile device may comprise one or more of: a channel measurement of a wireless connection between the mobile device and the server device; and a load indicator of the distributed inference.

A wireless connection as used herein may refer to an at least unidirectional encoded transfer of information via wireless/radio communication. For example, a wireless connection may comprise a 4G or 5G cellular connection or a WIFI/WLAN connection.

In a possible implementation form, the channel measurement may comprise a channel quality indicator.

A channel quality indicator as used herein may refer to an indicator being indicative of a quality of a communication channel, such as a signal-to-noise ratio (SNR), a signal-to-interference plus noise ratio (SINR), a bit-error-ratio (BER) and the like.

In a possible implementation form, the load indicator may comprise one or more of: a queue length of a queue of data samples of the mobile device, the queue including the data sample; and a status of the server device. For example, the status of the server device may comprise an indication of a(n) (un)successful remote inference of the remote exit result by the server device, an indication of a positive (ACK) or negative (NACK) acknowledgement by the server device 3 in response to a packet transfer via the wireless connection, an indication of a timeout of a packet transfer via the wireless connection by the mobile device 2 or by the server device 3, and so on.

In a possible implementation form, forwarding the processed data sample may comprise: forwarding the processed data sample to the third DNN inference function of the mobile device, if the indicator for local inference is set.

In a possible implementation form, forwarding the processed data sample may comprise: transmitting the processed data sample via the wireless connection to the server device, if the indicator for remote inference is set.

In a possible implementation form, providing the final result may comprise: providing the final result of the initiated local inference in accordance with the fifth inference function and the local exit result of the local inference, if the indicator for high accuracy is not set and if the indicator for local inference is set; providing the final result of the initiated remote inference in accordance with the fifth inference function and the remote exit result of the initiated remote inference received via the wireless connection from the server device, if the indicator for high accuracy is not set and if the indicator for remote inference is set; or providing the final result of the initiated local and remote inference in accordance with the fifth inference function, the local exit result of the initiated local inference, and the remote exit result of the initiated remote inference received via the wireless connection from the server device, if the indicator for high accuracy is set.

In a possible implementation form, the first, third and fourth DNN inference functions may respectively comprise a convolutional neural network or a fully-connected feedforward neural network.

A feedforward neural network as used herein may refer to an artificial neural network architecture typically comprising a recurring feed-forward structure of one or more layers wherein connections between the nodes do not form a cycle.

A convolutional neural network (CNN) as used herein may refer to a feedforward neural network most commonly applied to analyze digital images and typically comprising a recurring structure of one or more convolutional layers followed by a pooling layer. The convolutional layers extract features from a data sample such as a two-dimensional digital image, whereas the pooling layers diminish a redundancy of the extracted features by combining the outputs of neuron clusters at one layer into a single neuron in the next layer.

In a possible implementation form, the method may further comprise: performing a joint training of the first, third and fourth DNN inference functions in accordance with supervised learning.

In a possible implementation form, performing the joint training of the first, third and fourth DNN inference functions may comprise: computing a joint loss of In a possible implementation form, the initiated local inference and remote inference in accordance with a target result associated with the data sample, the local exit result and the remote exit result; and updating the respective weight parameters of the first, third and fourth DNN inference functions, in accordance with a backpropagation technique and the joint loss.

In a possible implementation form, computing the joint loss may comprise: computing the joint loss of the initiated local inference and remote inference in accordance with the target result associated with the data sample, and an average of the local exit result and the remote exit result.

In a possible implementation form, computing the joint loss may comprise: computing a first loss of the local exit result of the initiated local inference in accordance with weight parameters of the first DNN inference function, weight parameters of the third DNN inference function, a target result associated with the data sample, and the local exit result; computing a second loss of the remote exit result of the initiated remote inference in accordance with the weight parameters of the first DNN inference function, weight parameters of the fourth DNN inference function, the target result associated with the data sample, and the remote exit result; and computing the joint loss of the initiated local inference and remote inference in accordance with the first loss and the second loss.

In a possible implementation form, computing the joint loss may comprise: computing the joint loss in accordance with a linear combination of the first loss and the second loss, may be based on a loss weight of the first loss and a loss weight of the second loss.

In a possible implementation form, computing the joint loss may comprise: computing the joint loss in accordance with a mean squared error (MSE) loss function or a cross-entropy loss function, the local exit result, the remote exit result, and the target result associated with the data sample.

In a possible implementation form, the second DNN inference function may comprise a policy Deep Q-network (DQN), a target DQN and a state transition memory. The policy DQN and the target DQN may be configured to provide a respective first Q-value associated with local inference and a respective second Q-value associated with remote inference. The target DQN may further be configured to copy weight parameters from the policy DQN every K training steps.

In a possible implementation form, the method may further comprise: performing a training of the second DNN inference function in accordance with reinforcement learning, RL.

In a possible implementation form, performing the training of the second DNN inference function may comprise: determining the first Q-value and the second Q-value of the policy DQN in accordance with a state of the environment of the mobile device before taking an action; initiating the local inference or the remote inference in accordance with a smaller one of the determined first Q-value and the determined second Q-value; observing one or more of: a latency from a start of the processing of the data sample to an end of the determining of the final result, a penalty on the queue length of the queue of data samples, the first loss of the local exit result of the initiated local inference, and the second loss of the remote exit result of the initiated remote inference; determining a cost associated with the initiated local inference or remote inference; populating the state transition memory with a tuple comprising the state before taking the action, the action, the cost associated with the action, and a state of the environment of the mobile device after taking the action; sampling a training batch from the state transition memory; and updating the weight parameters of the second DNN inference function in accordance with a backpropagation technique and a prediction error between the policy DQN and the target DQN of the second DNN inference function for the sampled training batch.

In a possible implementation form, initiating the local inference or the remote inference may comprise: initiating the local inference, if the first Q-value of the policy DQN and being associated with the local inference is smaller than or equal to the second Q-value of the policy DQN and being associated with the remote inference; and initiating the remote inference, if the first Q-value of the policy DQN and being associated with the local inference is greater than the second Q-value of the policy DQN and being associated with the remote inference.

In a possible implementation form, determining the cost associated with the initiated local inference or remote inference may comprise: determining the cost in accordance with a sum of the first loss, the latency and the penalty, if the local inference is initiated; determining the cost in accordance with a sum of the latency and the penalty, if the remote inference is initiated and if the change of the state relates to an unsuccessful remote inference of the remote exit result by the server device; and determining the cost in accordance with a sum of the second loss, the latency and the penalty, if the remote inference is initiated and if the change of the state relates to a successful remote inference of the remote exit result by the server device.

In a possible implementation form, the state of the environment may be subject to one or more changes during a lifetime of the data sample.

In a possible implementation form, the fifth inference function may comprise a fifth DNN inference function including a convolutional neural network or a fully-connected feedforward neural network.

In a possible implementation form, the method may further comprise: performing a training of the fifth DNN inference function in accordance with supervised learning.

In a possible implementation form, performing the training of the fifth DNN inference function may comprise: computing a loss in accordance with weight parameters of the fifth DNN inference function, the target result associated with the data sample, and the final result; and updating the weight parameters of the fifth DNN inference function in accordance with a backpropagation technique and the loss.

In a possible implementation form, computing the loss may comprise: computing the loss) in accordance with the MSE loss function, the target result and the final result.

In a possible implementation form, computing the loss may comprise: computing the loss in accordance with the cross-entropy loss function, the target result and the final result.

According to a second aspect, a system of distributed inference is provided, the system comprising a mobile device and a server device, and being configured to perform the method of any one of the preceding claims.

According to a third aspect, a computer program is provided, comprising a program code for performing the method according to the first aspect or any of its implementations, when executed on a computer.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a block diagram of a system 2 of distributed inference in accordance with the present disclosure;

FIGS. 2-6 illustrate exemplary implementations of various inference functions of the system of FIG. 1;

FIG. 7 illustrates a flow diagram of a method of distributed inference in accordance with the present disclosure;

FIG. 8 illustrates step 15 of the method of FIG. 7 in more detail;

FIG. 9 illustrates step 16 of the method of FIG. 7 in more detail;

FIG. 10 illustrates step 19 of the method of FIG. 7 in more detail;

FIG. 11 illustrates step 11 of the method of FIG. 7 in more detail;

FIG. 12 illustrates step 12 of the method of FIG. 7 in more detail; and

FIG. 13 illustrates step 13 of the method of FIG. 7 in more detail.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

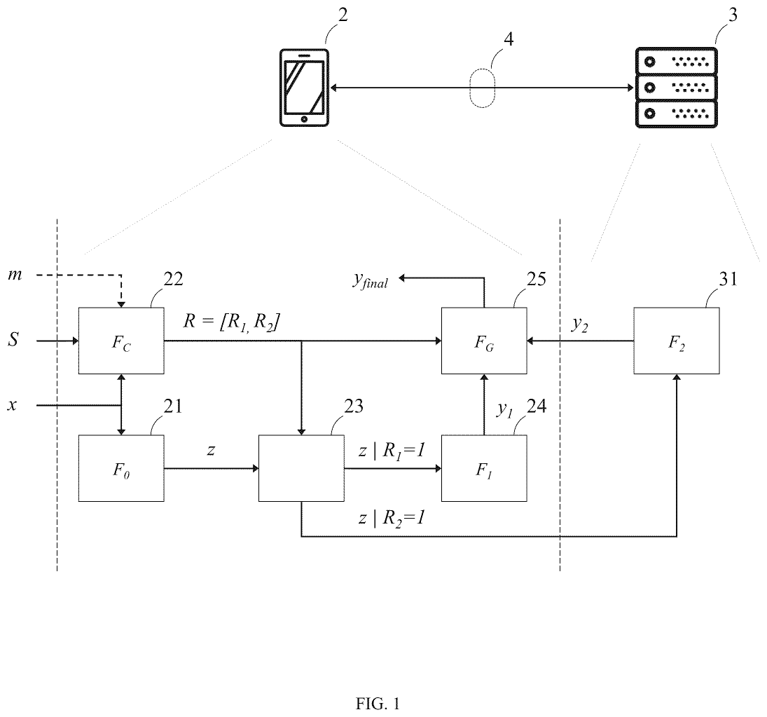

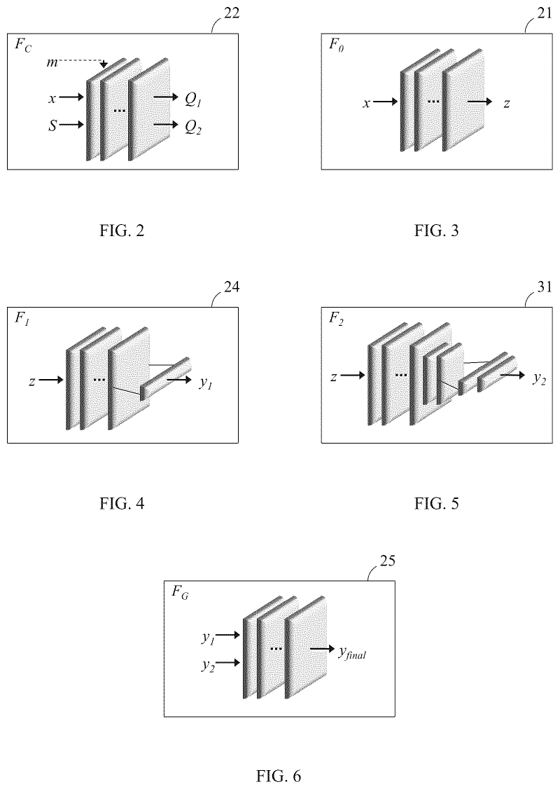

FIG. 1 illustrates a block diagram of a system 2, 3 of distributed inference in accordance with the present disclosure, and FIGS. 2-6 illustrate exemplary implementations of various inference functions 21, 22, 24, 25, 31 of the system 2, 3 of FIG. 1.

FIG. 1 is separated into three sections: inputs (to the left), a mobile device 2 (in the middle), and a server device 3 (to the right).

The inputs comprise a data sample x, a state S of the environment of the mobile device 2, and optionally an indicator m for high accuracy of an inference.

The data sample x represents the incoming data sample for which the mobile device 2 has to return a prediction. The state S could be any set of observed measurements, such as (i) a channel state (e.g. lossy), (ii) a device buffer status (e.g., a number of data samples x in a queue), and (iii) server status (e.g. extremely busy). The indicator m may be indicative for high accuracy of inference when being set (m=1), or may be indicative for low accuracy of inference when not being set (m=0).

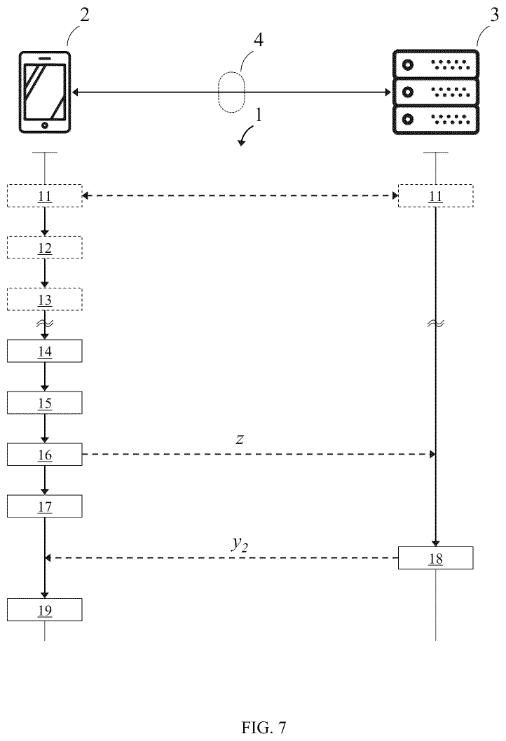

The system 2, 3 of comprises the mobile device 2 and the server device 3, and is configured to perform the method 1 of the first aspect (see FIG. 7 below) or any of its implementations.

The mobile device 2 comprises a first deep neural network, DNN, inference function F₀, 21 being configured to process 14 the data sample x into a processed data sample z. The first DNN inference function F₀, 21 may comprise a convolutional neural network or a fully-connected feedforward neural network (see FIG. 3).

The above-mentioned data sample x may comprise one of: a digital image, and a portion of a time series.

The above-mentioned state S of the environment of the mobile device 2 may comprise one or more of: a channel measurement of the wireless connection 4 between the mobile device 2 and the server device 3, such as a channel quality indicator c∈{1, . . . , C}; and a load indicator of the distributed inference, e.g., one or more of: a queue length q∈{0, 1, . . . , K} of a queue of data samples of the mobile device 2 including the data sample x; and a status of the server device 3. The state S=[c,q] of the environment may be subject to one or more changes during a lifetime of the data sample x.

The mobile device 2 further comprises a second DNN inference function F_{C}, 22 being configured to initiate 15 a local inference and/or a remote inference in accordance with the data sample x, a state S of an environment of the mobile device 2, and optionally an indicator m for high accuracy of the initiated inference. The second DNN inference function F_{C}, 22 may especially comprise a policy DQN (see FIG. 2), a target DQN (same as FIG. 2) and a state transition memory B_{C} (not shown). The policy DQN and the target DQN may be configured to provide a respective first Q-value Q₁(x, S) associated with local inference and a respective second Q-value Q₂(x, S) associated with remote inference. The policy DQN and the target DQN generally correspond to one another. However, the target DQN may further be configured to copy weight parameters θ_{C} from the policy DQN every K training steps. For example, the weight parameters θ_{C} of the target DQN may remain constant for K=1.000 training steps of the policy DQN.

The mobile device 2 further comprises a forwarding function 23 being configured to forward 16 the processed data sample z in accordance with the initiated local inference (R₁=1) and/or remote inference (R₂=1) to a third DNN inference function F₁, 24 of the mobile device 2 (for local inference) and/or a fourth DNN inference function F₂, 31 of the server device 3 (for remote inference). In other words, the second DNN inference function F_{C}, 22 is configured to dictate the forwarding function 23 where to send the processed data sample z. The forwarding function 23 may especially comprise a logic circuit.

In an energy saving mode (m=0, default mode), the second DNN inference function F_{C}, 22 may invoke local inference (R₁=1) or remote inference (R₂=1). In an accuracy mode (m=1), the second DNN inference function F_{C}, 22 is bypassed and both local inference (R₁=1) and remote inference (R₂=1) are invoked.

The mobile device 2 further comprises the third DNN inference function F₁, 24 being configured to determine 17 an local exit result y₁ of the initiated local inference (R₁=1) in accordance with the processed data sample z. The third DNN inference function F₁, 24 may comprise a convolutional neural network or a fully-connected feedforward neural network (see FIG. 4).

The server device 3 comprises the fourth DNN inference function F₂, 31 being configured to determine 18 a remote exit result y₂ of the initiated remote inference (R₂=1) in accordance with the processed data sample z. The fourth DNN inference function F₂, 31 may especially comprise a convolutional neural network or a fully-connected feedforward neural network (see FIG. 5).

The mobile device 2 further comprises a fifth inference function F_{G}, 25, which may comprise a fifth DNN inference function F_{G}, 25 being configured to provide 19 a final result y_{final} of the initiated local and/or remote inference in accordance with the local exit result y₁ of the initiated local inference (R₁=1) and/or the remote exit result y₂ of the initiated remote inference (R₂=1). The fifth DNN inference function F_{G}, 25 may comprise a convolutional neural network or a fully-connected feedforward neural network (see FIG. 6).

Thus in the energy saving mode (m=0), the fifth (DNN) inference function F_{G}, 25 may be configured to receive one prediction (e.g., one of the local exit result y₁ and the remote exit result y₂ and output it as the final result y_{final}. In the accuracy mode (m=1), the fifth (DNN) inference function F_{G}, 25 receives both predictions and to apply a function, which may be trainable, in order to provide the final result y_{final}.

FIG. 7 illustrates a flow diagram of a method 1 of distributed inference in accordance with the present disclosure.

The method 1 may comprise performing 11 a joint training of the first, third and fourth DNN inference functions F₀, 21, F₁, 24, F₂, 31 in accordance with supervised learning. As the first and third DNN inference functions F₀, 21, F₁, 24 form part of the mobile device 2 and the fourth DNN inference function F₂, 31 forms part of the server device 2, both centralized training (being suggested by the dashed horizontal arrow between the steps identified as 11 at the mobile device 2 and the server device 3, respectively; according to this, after having trained the model and acquired θ₀, θ₁, θ₂ on the server device 3, the weight parameters θ₀, θ₁ are shared with the mobile device 2) and distributed training (also being suggested by the dashed horizontal arrow between the steps identified as 11 at the mobile device 2 and the server device 3) can be used, as the mobile device 2 and the server device 3 can be located far apart.

A joint training as used herein may refer to a training approach for binding the first, third and fourth DNN inference functions F₀, 21, F₁, 24, F₂, 31.

The method 1 may further comprise performing 12 a training of the second DNN inference function F_{C}, 22 in accordance with reinforcement learning (RL).

The method 1 may further comprise performing 13 a training of the fifth DNN inference function F_{G}, 25, again in accordance with supervised learning.

This concludes a training phase and opens an inference phase of the method 1 (and the system 2, 3).

The method 1 further comprises processing 14 a data sample x in accordance with a first deep neural network, DNN, inference function F₀, 21 of a mobile device 2.

The method 1 further comprises initiating 15 a local and/or a remote inference in accordance with a second DNN inference function F_{C}, 22 of the mobile device 2.

The method 1 further comprises forwarding 16 the processed data sample z in accordance with the initiated local and/or remote inference.

The forwarding 16 may comprise forwarding 161 the processed data sample z within the mobile device 2 to the third DNN inference function F₁, 24.

If so, then the method 1 further comprises determining 17 an local exit result y₁ of the initiated local inference in accordance with a third DNN inference function F₁, 24 of the mobile device 2 and the processed data sample z.

However, the forwarding 16 may additionally or alternatively comprise transmitting 162 the processed data sample z via the wireless connection 4 to the server device 3, as is indicated by the dashed horizontal arrow from step 16 at the mobile device 2 to the server device 3.

If so, then the method 1 further comprises determining 18 a remote exit result y₂ of the initiated remote inference in accordance with a fourth DNN inference function F₂, 31 of the server device 3 and the processed data sample z.

The method 1 further comprises providing 19 a final result y_{final} of the initiated local and/or remote inference in accordance with a fifth inference function F_{G}, 25, the local exit result y₁ of the initiated local inference and/or the remote exit result y₂ of the initiated remote inference.

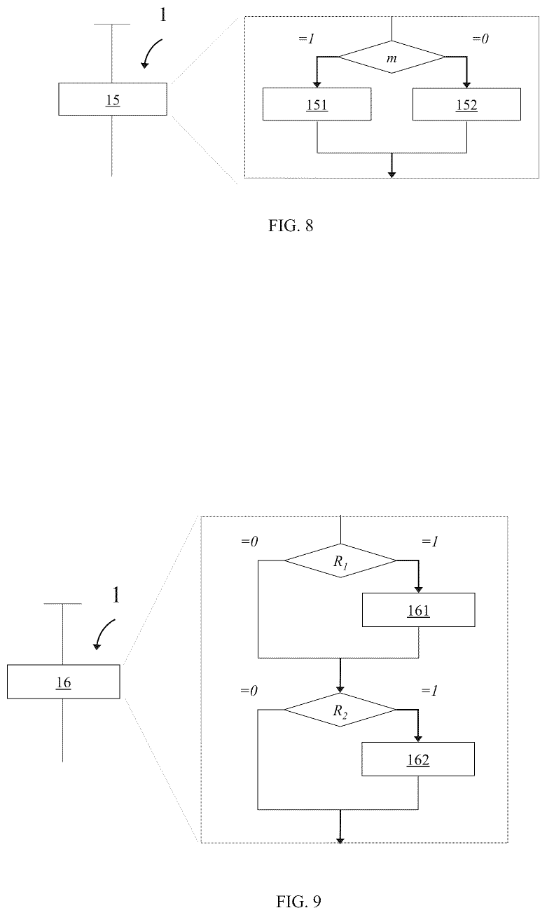

FIG. 8 illustrates step 15 of the method 1 of FIG. 7 in more detail.

According to this refinement, initiating 15 the local inference and/or the remote inference may comprise: providing 151 respective indicators for local inference R₁ and remote inference R₂ as being set, if an indicator m for high accuracy is set; and providing 152 the respective indicators for local inference R₁ and remote inference R₂ in accordance with the second DNN inference function F_{C}, 22, the data sample x and a state S of an environment of the mobile device 2, if an indicator m for high accuracy is not set.

FIG. 9 illustrates step 16 of the method 1 of FIG. 7 in more detail.

According to this refinement, forwarding 16 the processed data sample z may comprise: forwarding 161 the processed data sample z to the third DNN inference function F₁, 24 of the mobile device 2, if the indicator for local inference R₁ is set.

Alternatively or additionally, forwarding 16 the processed data sample z may comprise: transmitting 162 the processed data sample z via the wireless connection 4 to the server device 3, if the indicator for remote inference R₂ is set.

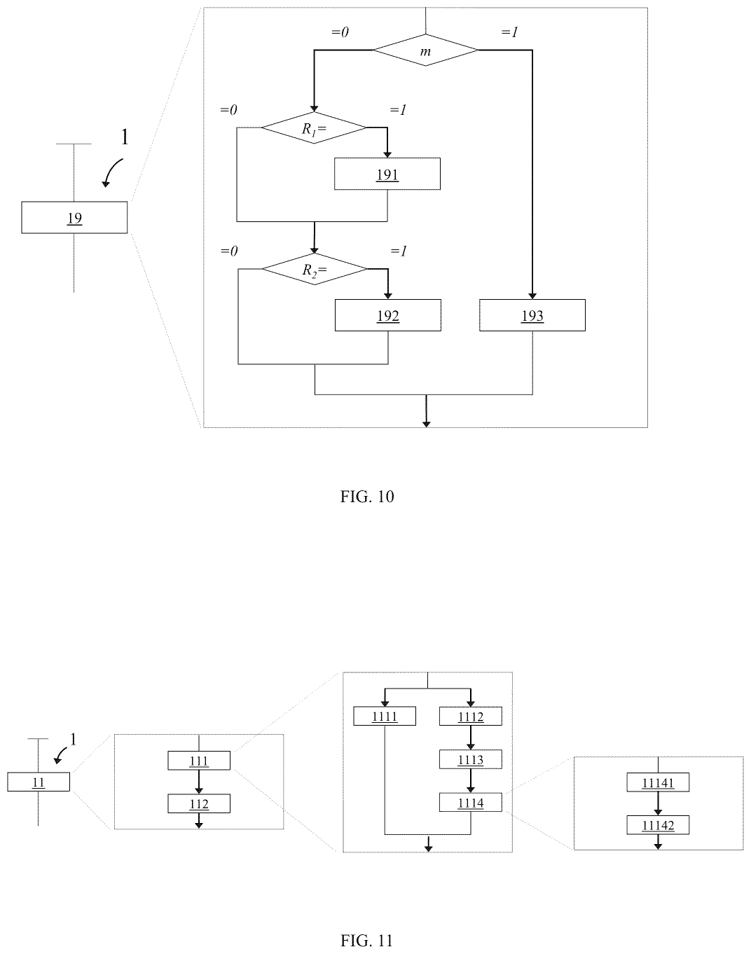

FIG. 10 illustrates step 19 of the method 1 of FIG. 7 in more detail.

According to this refinement, providing 19 the final result y_{final} may comprise: providing 191 the final result y_{final} of the initiated local inference in accordance with the fifth inference function F_{G}, 25 and the local exit result y₁ of the local inference, if the indicator m for high accuracy is not set and if the indicator R₁ for local inference is set; providing 192 the final result y_{final} of the initiated remote inference in accordance with the fifth inference function F_{G}, 25 and the remote exit result y₂ of the initiated remote inference received via the wireless connection 4 from the server device 3, if the indicator m for high accuracy is not set and if the indicator R₂ for remote inference is set; or providing 193 the final result y_{final} of the initiated local and remote inference in accordance with the fifth inference function F_{G}, 25, the local exit result y₁ of the initiated local inference and the remote exit result y₂ of the initiated remote inference received via the wireless connection 4 from the server device 3, if the indicator m for high accuracy is set.

FIG. 11 illustrates step 11 of the method 1 of FIG. 7 in more detail.

According to this refinement, performing 11 the joint training of the first, third and fourth DNN inference functions F₀, 21, F₁, 24, F₂, 31 may comprise: computing 111 a joint loss L=L(y, y₁, y₂) of the initiated local inference and remote inference in accordance with a target result y associated with the data sample x, the local exit result y₁ and the remote exit result y₂; and updating 112 the respective weight parameters θ₀, θ₁, θ₂ of the first, third and fourth DNN inference functions F₀, 21, F₁, 24, F₂, 31, in accordance with a backpropagation technique and the joint loss L.

The target result y denotes the true desired output (label).

According to a further refinement, computing 111 the joint loss L=L(y, y₁, y₂) may comprise: computing 1111 the joint loss

$$L = L ( y , \frac{( {y}_{1} + {y}_{2} )}{2} )$$

of the initiated local inference and remote inference in accordance with the target result y associate with the data sample x and an average

$$\frac{( {y}_{1} + {y}_{2} )}{2}$$

of the local exit result y₁ and the remote exit result y₂.

Alternatively, computing 111 the joint loss L=L(y, y₁, y₂) may comprise: computing 1112 a first loss L₁=L (y, y₁; θ₀, θ₁) of the local exit result y₁ of the initiated local inference in accordance with weight parameters θ₀ of the first DNN inference function F₀, 21, weight parameters θ₁ of the third DNN inference function F₁, 24, a target result y associated with the data sample x, and the local exit result y₁; computing 1113 a second loss L₂=L (y, y₂; θ₀, θ₂) of the remote exit result y₂ of the initiated remote inference in accordance with the weight parameters θ₀ of the first DNN inference function F₀, 21, weight parameters θ₂ of the fourth DNN inference function F₂, 31, the target result y associated with the data sample x, and the remote exit result y₂; and computing 1114 the joint loss L=f(L₁, L₂) of the initiated local inference and remote inference in accordance with the first loss L₁ and the second loss L₂.

According to a further refinement, computing 1114 the joint loss L=L(y, y₁, y₂) may comprise: computing 11141 the joint loss L=w₁L₁+w₂L₂ in accordance with a linear combination of the first loss L₁ and the second loss L₂ being based on a loss weight w₁ of the first loss L₁ and a loss weight w₂ of the second loss L₂. For example, given some known loss weights w₁, w₂ for each exit, and fixed weight parameters θ₀, θ₁, θ₂ for the inference functions F₀, F₁, F₂, the individual losses L₁, L₂ contribute to a total loss (which may subsequently be used for backpropagation) in an additive manner as follows: L=w₁L(y, y₁; θ₀, θ₁)+w₂L(y, y₂; θ₀, θ₂).

Of note, if w₁=0, then only θ₀, θ₂ are trained (θ₁ is not), then this is a traditional DNN yielding only a remote exit result y₂ at the server device 3; technically, the local exit can still return local exit result y₁ predictions, but they are meaningless. In the other extreme case where w₂=0, then only θ₂ is never trained, and it is only the local exit that returns meaningful predictions.

The computing 1114 of the joint loss may further comprise: computing 11142 the joint loss L=L(y, y₁, y₂) in accordance with an MSE loss function or a cross-entropy loss function, the local exit result y₁, the remote exit result y₂, and the target result y associated with the data sample x. For example, the choice of function L has to do with the ML task that one is interested in (e.g. MSE loss function for regression).

FIG. 12 illustrates step 12 of the method 1 of FIG. 7 in more detail.

According to this refinement, performing 12 the training of the second DNN inference function F_{C}, 22 may comprise: determining 121 the first Q-value Q₁(x, S) and the second Q-value Q₂(x,S) of the policy DQN in accordance with a state S=[c, q] of the environment of the mobile device 2 before taking an action; initiating 122 the local inference (R=[R₁, R₂]=[1,0]) or the remote inference (R=[R₁, R₂]=[0,1]) in accordance with a smaller one of the determined first Q-value Q₁(x,S) and the determined second Q-value Q₂(x, S); observing 123 one or more of: a latency d from a start of the processing of the data sample x to an end of the determining of the final result y_{final}, a penalty g(q) on the queue length q of the queue of data samples, the first loss L(y, y₁; θ₁) of the local exit result y₁ of the initiated local inference, and the second loss L(y, y₂; θ₂) of the remote exit result y₂ of the initiated remote inference; determining 124 a cost (cost) associated with the initiated local inference (R₁=1) or remote inference (R₂=1); populating 125 the state transition memory B_{C} with a tuple {[x,S], R, cost, [x,S′]} comprising the state S=[c, q] before taking the action, the action R, the cost (cost) associated with the action R, and a state S′=[c′, q′] of the environment of the mobile device 2 after taking the action R; sampling 126 a training batch from the state transition memory B_{C}; and updating 127 the weight parameters θ_{C} of the second DNN inference function F_{C}, 22 in accordance with a backpropagation technique and a prediction error between the policy DQN and the target DQN of the second DNN inference function F_{C}, 22 for the sampled training batch.

According to a further refinement, initiating 122 the local inference or the remote inference may comprise: initiating 1221 the local inference (R₁=1), if the first Q-value Q₁(x,S) of the policy DQN and being associated with the local inference is smaller than or equal to the second Q-value Q₂(x,S) of the policy DQN and being associated with the remote inference; and initiating 1222 the remote inference (R₂=1), if the first Q-value Q₁(x,S) of the policy DQN and being associated with the local inference is greater than the second Q-value Q₂(x,S) of the policy DQN and being associated with the remote inference.

According to a further refinement, determining 124 the cost (cost) associated with the initiated local inference or remote inference may comprise: determining 1241 the cost (cost=L(y, y₁; θ₁)+d+g(q)) in accordance with a sum of the first loss L(y, y₁; θ₁), the latency d and the penalty g(q), if the local inference is initiated (R₁=1); determining 1242 the cost (cost=d+g(q)) in accordance with a sum of the latency d and the penalty g(q), if the remote inference is initiated (R₂=1) and if the change of the state relates to an unsuccessful remote inference of the remote exit result y₂ by the server device 3; and determining 1243 the cost (cost=L(y, y₂; θ₂)+d+g(q)) in accordance with a sum of the second loss L(y, y₂; θ₂), the latency d and the penalty g(q), if the remote inference is initiated (R₂=1) and if the change of the state relates to a successful remote inference of the remote exit result y₂ by the server device 3.

A key contribution of the present disclosure includes the second DNN inference function F_{C}, 22, whose training approach is explained in this section. This function is used in the energy saving mode (m=0, default) of the mobile device 2. The training obviously has nothing to do with the used-defined signal m, and therefore, the input data for the second DNN inference function F_{C}, 22 are the data sample x and the state S of the environment of the mobile device 2.

In accordance with the RL-based training approach, the first, third and fourth DNN inference functions F₀, 21, F₁, 24, F₂, 31 form part of the environment. Arriving data samples x are treated in a First Come First Served (FCFS) manner. Additionally, at time t, the channel quality indicator c∈{1, . . . , C}, and the queue length q∈{0, 1, . . . , K} of the queue of data samples of the mobile device 2 are observed; these form the state S=[c, q] of the environment of the mobile device 2.

As already mentioned previously, the second DNN inference function F_{C}, 22 may be represented as a DQN due to (a) a very large state space ([x,S] where x can be an image) and (b) a small action space (only two possible actions). The RL agent (of the RL training approach) thus comprises an experience buffer B_{C} and two DNNs: a target DNN and a policy DNN. The RL state is the tuple [x, S], the actions are “do locally” (R₁=1) and “do remotely” (R₂=1), and therefore at the exit of the policy DQN we see two Q-values Q₁(x,S), Q₂(x,S) of which the smaller (e.g., with the smaller cost) is chosen. Hence, if Q₁(x, S)>Q₂(x, S), then R=[R₁, R₂]=[0,1]; else R=[R₁, R₂]=[1, 0].

During the RL-based training, the environment evolves. When the mobile device 2 sends a packet (e.g. processed data sample z) to the server device 3 for processing (i.e., demands prediction y₂ from it), one of the following may occur:
a) the packet gets lost; or the server device 3 is busy; or the server device 3 responded with an ACK (good reception of packet z) but returned the prediction y₂ too late, for instance, by exceeding the acceptable timeout duration (in all those cases, a timeout flag is raised);
b) the server device 3 received erroneously the packet transmitted by the mobile device 2 (server sends a NACK to the device), or the mobile device 2 received erroneously the response of the server device 3 (e.g., by doing parity check) and an error flag is raised;
c) the server device 3 receives z successfully, sends an ACK to device and the server device's 3 prediction arrives at the mobile device 2 on time (e.g., before the timeout).

In cases a) and b), the mobile device 2 has to make a new decision on how to proceed with data sample x potentially with different environment state S=[c, q](q increased and c has changed); in case c) the mobile device 2 received successfully the remote exit result from the server device 3.

The reward is determined as follows: when any of the above events happens, the latency d from a start of the processing of the data sample x to an end of the determining of the final result y_{final} and a penalty g(q) on the queue length q of the queue of data samples are observed. When a prediction yᵢ (of the exit i from which a prediction was demanded) is available, also a corresponding loss L(y, yᵢ) is observed. The actor further receives the data sample x and the environment state S (the RL state is [x,S]), outputs action R=[R₁,R₂], receives as a result of its action the value cost, and transitions into the new environment state [x′, S′]. The state transition memory B_{C} stores RL tuple {[x, S], R, cost, [x′, S′]}.

The cost of the action R depends on the same as follows:
For R=[1, 0], a local prediction yᵢ is obtained with cost=L(y, y₁)+d+f(q)
For R=[0, 1]: a remote prediction y₂ is requested from the server device 3, and the following events may occur:
   “timeout” or “error flag” or “NACK”, e.g., cases a), b) above: cost=d+f(q)
   “prediction y₂ from server returns successfully”: cost=L(y, y₂)+d+f(q)

A given data sample x may experience multiple states S of the environment until it is finally resolved (meaning there may be environment changes during the lifetime of a data sample x).

After every state transition S→S′, a batch is sampled from the state transition memory B_{C} and the weight parameters θ_{C} of the second DNN inference function F_{C}, 22 are updated in accordance with a standard backpropagation technique.

A new data sample x may be fetched from the queue of data samples to repeat the RL-based training process.

The training process is, in general, not carried out online: As stated above, the reward contains L(y, yᵢ) (with i=1 or 2); hence, measuring the loss requires knowledge of the target value y (the ground-truth). For the case of image classification, this is not possible to have in an online fashion, as it implies that one knows the true label of the new unseen image during training, which is unrealistic. Therefore, for the case of image classification the training is done in an offline manner, and during testing the DQN is not observing losses, and hence is not getting updated. However, when considering timeseries-related tasks, online training is possible. In such tasks, some prediction is made for the next time instance given some past time samples—after making the prediction, the true value of the predicted variable is available, and therefore the loss can be measured, stored in the state transition memory B_{C}, and online DQN training may be performed.

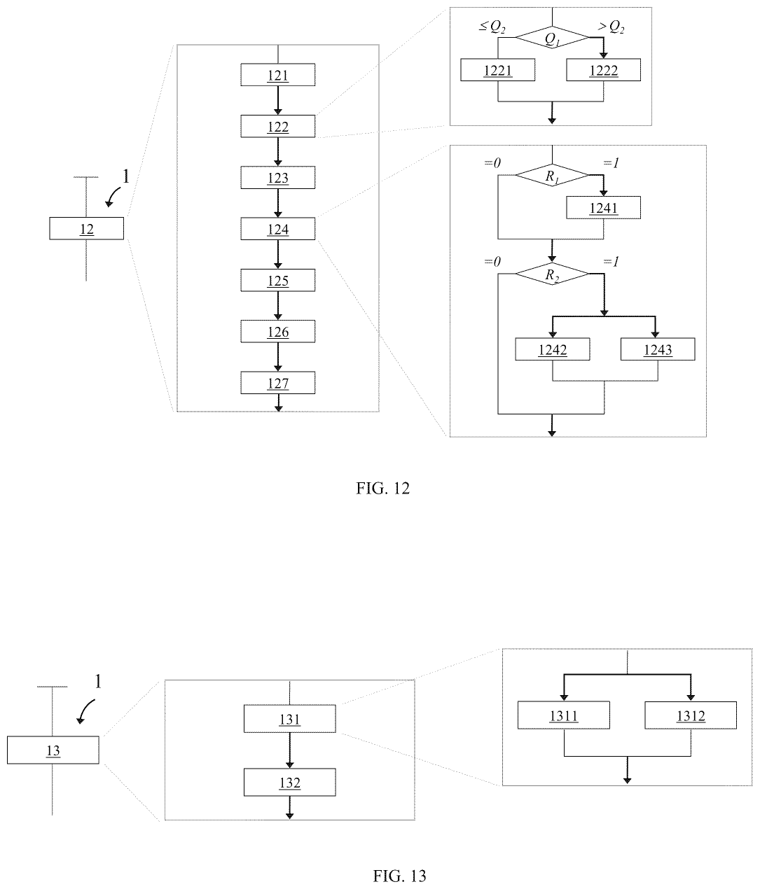

FIG. 13 illustrates step 13 of the method 1 of FIG. 7 in more detail.

According to the refinement, performing 13 the training of the fifth DNN inference function F_{G}, 25 may comprise: computing 131 a loss LG L(y, y_{final}; θ_{G}) in accordance with weight parameters BG of the fifth DNN inference function F_{G}, 25, the target result y associated with the data sample x, and the final result y_{final}; and updating 132 the weight parameters BG of the fifth DNN inference function F₀, 21 in accordance with a backpropagation technique and the loss LG.

According to a further refinement, computing 131 the loss may comprise: computing 1311 the loss L=L(y, y_{final}; θ_{G})=∥y−y_{final}∥₂²) in accordance with the MSE loss function, the target result y and the final result y_{final}.

Alternatively, computing 131 the loss may comprise: computing 1312 the loss L=CrossEntropy(y, y_{final}) in accordance with the cross-entropy loss function, the target result y and the final result y_{final}.

In the accuracy mode (m=1), the fifth DNN inference function F_{G}, 25 receives both predictions y₁, y₂ of the two exits, which predictions are used in order to train F_{G} to yield a final result y_{final} that uses both.

Formally, the final prediction is y_{final}=F (y₁,y₂), and for a given set of weight parameters θ_{G} the measured loss is Loss=L(y, y_{final}; θ_{G}).

For example, time series tracking may involve L(y, y_{final}; θ_{G})=∥y−y_{final}∥₂²=∥y−F_{G}(y₁, y₂)∥₂², and image classification may involve L(y, y_{final}; θ_{G}) CrossEntropy(y, y_{final})=CrossEntropy(y, F_{G}(y₁, y₂)).

The present disclosure has been described in conjunction with various implementations as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. A method (1) of distributed inference, the method (1) comprising
processing (14) a data sample (x) in accordance with a first deep neural network, DNN, inference function (F₀, 21) of a mobile device (2);
initiating (15) a local and/or a remote inference in accordance with a second DNN inference function (F_{C}, 22) of the mobile device (2);
forwarding (16) the processed data sample (z) in accordance with the initiated local and/or remote inference;
determining (17) a local exit result (y₁) of the initiated local inference in accordance with a third DNN inference function (F₁, 24) of the mobile device (2) and the processed data sample (z);
determining (18) a remote exit result (y₂) of the initiated remote inference in accordance with a fourth DNN inference function (F₂, 31) of the server device (3) and the processed data sample (z); and
providing (19) a final result (y_{final}) of the initiated local and/or remote inference in accordance with a fifth inference function (F_{G}, 25).

2. The method (1) of claim 1,
wherein initiating (15) the local inference and/or the remote inference comprises
providing (151) respective indicators for local inference (R₁) and remote inference (R₂) as being set, if an indicator for high accuracy (m) is set; and
providing (152) the respective indicators for local inference (R₁) and remote inference (R₂) in accordance with the second DNN inference function (F_{C}, 22), the data sample (x) and a state (S) of an environment of the mobile device (2), if an indicator for high accuracy (m) is not set.

3. The method (1) of claim 2,
the data sample (x) comprising one of: a digital image, and a portion of a time series.

4. The method (1) of claim 2,
the state (S) of the environment of the mobile device (2) comprising one or more of:
a channel measurement of the wireless connection (4) between the mobile device (2) and the server device (3); and
a load indicator of the distributed inference.

5. The method (1) of claim 4,
the channel measurement comprising a channel quality indicator (c∈{1, . . . , C}).

6. The method (1) of claim 4,
the load indicator comprising one or more of:
a queue length (q∈{0, 1, . . . , K}) of a queue of data samples of the mobile device (2), the queue including the data sample (x);
and
a status of the server device (3).

7. The method (1) of claim 1,
wherein forwarding (16) the processed data sample (z) comprises
forwarding (161) the processed data sample (z) to the third DNN inference function (F₁, 24) of the mobile device (2), if the indicator for local inference (R₁) is set.

8. The method (1) of claim 1,
wherein forwarding (16) the processed data sample (z) comprises
transmitting (162) the processed data sample (z) via the wireless connection (4) to the server device (3), if the indicator for remote inference (R₂) is set.

9. The method (1) of claim 1,
wherein providing (19) the final result (y_{final}) comprises
providing (191) the final result (y_{final}) of the initiated local inference in accordance with the fifth inference function (F_{G}, 25) and the local exit result (y₁) of the local inference, if the indicator for high accuracy (m) is not set and if the indicator for local inference (R₁) is set;
providing (192) the final result (y_{final}) of the initiated remote inference in accordance with the fifth inference function (F_{G}, 25) and the remote exit result (y₂) of the initiated remote inference received via the wireless connection (4) from the server device (3), if the indicator for high accuracy (m) is not set and if the indicator for remote inference (R₂) is set; or
providing (193) the final result (y_{final}) of the initiated local and remote inference in accordance with the fifth inference function (F_{G}, 25), the local exit result (y₁) of the initiated local inference, and the remote exit result (y₂) of the initiated remote inference received via the wireless connection (4) from the server device (3), if the indicator for high accuracy (m) is set.

10. The method (1) of claim 1,
the first, third and fourth DNN inference functions (F₀, 21, F₁, 24, F₂, 31) respectively comprising a convolutional neural network or a fully-connected feedforward neural network.

11. The method (1) of claim 10, further comprising
performing (11) a joint training of the first, third and fourth DNN inference functions (F₀, 21, F₁, 24, F₂, 31) in accordance with supervised learning.

12. The method (1) of claim 11, wherein performing (11) the joint training of the first, third and fourth DNN inference functions (F₀, 21, F₁, 24, F₂, 31) comprises
computing (111) a joint loss (L=L(y, y₁, y₂)) of the initiated local inference and remote inference in accordance with a target result (y) associated with the data sample (x), the local exit result (y₁) and the remote exit result (y₂); and
updating (112) the respective weight parameters (θ₀, θ₁, θ₂) of the first, third and fourth DNN inference functions (F₀, 21, F₁, 24, F₂, 31), in accordance with a backpropagation technique and the joint loss (L).

13. The method (1) of claim 12, wherein computing (111) the joint loss (L=L(y, y₁, y₂)) comprises
computing (1111) the joint loss
$$( L = L ( y , \frac{( {y}_{1} + {y}_{2} )}{2} ) )$$
of the initiated local inference and remote inference in accordance with the target result (y) associated with the data sample (x), and an average
$$( \frac{( {y}_{1} + {y}_{2} )}{2} )$$
of the local exit result (y₁) and the remote exit result (y₂).

14. The method (1) of claim 12, wherein computing (111) the joint loss (L=L(y, y₁, y₂)) comprises
computing (1112) a first loss (L₁=L(y, y₁; θ₀, θ₁)) of the local exit result (y₁) of the initiated local inference in accordance with weight parameters (θ₀) of the first DNN inference function (F₀, 21), weight parameters (θ₁) of the third DNN inference function (F₁, 24), a target result (y) associated with the data sample (x), and the local exit result (y₁);
computing (1113) a second loss (L₂=L(y, y₂; θ₀, θ₂)) of the remote exit result (y₂) of the initiated remote inference in accordance with the weight parameters (θ₀) of the first DNN inference function (F₀, 21), weight parameters (θ₂) of the fourth DNN inference function (F₂, 31), the target result (y) associated with the data sample (x), and the remote exit result (y₂); and
computing (1114) the joint loss (L=f(L₁, L₂)) of the initiated local inference and remote inference in accordance with the first loss (L₁) and the second loss (L₂).

15. The method (1) of claim 14, wherein computing (1114) the joint loss (L=L(y, y₁, y₂)) comprises
computing (11141) the joint loss (L=w₁L₁+w₂L₂) in accordance with a linear combination of the first loss (L₁) and the second loss (L₂), being based on a loss weight (w₁) of the first loss (L₁) and a loss weight (w₂) of the second loss (L₂).

16. The method (1) of claim 12, wherein computing (1114) the joint loss comprises
computing (11142) the joint loss (L=L(y, y₁, y₂)) in accordance with a mean squared error, MSE, loss function or a cross-entropy loss function, the local exit result (y₁), the remote exit result (y₂), and the target result (y) associated with the data sample (x).

17. The method (1) of claim 12,
the second DNN inference function (F_{C}, 22) comprising a policy Deep Q-network, DQN, a target DQN and a state transition memory (B_{C}), the policy DQN and the target DQN being configured to provide a respective first Q-value (Q₁(x, S)) associated with local inference and a respective second Q-value (Q₂(x, S)) associated with remote inference, the target DQN further being configured to copy weight parameters (θ_{C}) from the policy DQN every K training steps.

18. The method (1) of claim 17, further comprising
performing (12) a training of the second DNN inference function (F_{C}, 22) in accordance with reinforcement learning, RL.

19. A non-transitory computer-readable storage medium, wherein the non-transitory computer-readable storage medium stores a computer-executable code or instructions, and when the computer-executable code or instructions are invoked by a computer, the method according to the following is performed:
processing (14) a data sample (x) in accordance with a first deep neural network, DNN, inference function (F₀, 21) of a mobile device (2);
initiating (15) a local and/or a remote inference in accordance with a second DNN inference function (F_{C}, 22) of the mobile device (2);
forwarding (16) the processed data sample (z) in accordance with the initiated local and/or remote inference;
determining (17) a local exit result (y₁) of the initiated local inference in accordance with a third DNN inference function (F₁, 24) of the mobile device (2) and the processed data sample (z);
determining (18) a remote exit result (y₂) of the initiated remote inference in accordance with a fourth DNN inference function (F₂, 31) of the server device (3) and the processed data sample (z); and
providing (19) a final result (y_{final}) of the initiated local and/or remote inference in accordance with a fifth inference function (F_{G}, 25).

20. A computer program, comprising:
a program code or instructions for performing the method (1) according to the following when executed on a computer:
processing (14) a data sample (x) in accordance with a first deep neural network, DNN, inference function (F₀, 21) of a mobile device (2);
initiating (15) a local and/or a remote inference in accordance with a second DNN inference function (F_{C}, 22) of the mobile device (2);
forwarding (16) the processed data sample (z) in accordance with the initiated local and/or remote inference;
determining (17) a local exit result (y₁) of the initiated local inference in accordance with a third DNN inference function (F₁, 24) of the mobile device (2) and the processed data sample (z);
determining (18) a remote exit result (y₂) of the initiated remote inference in accordance with a fourth DNN inference function (F₂, 31) of the server device (3) and the processed data sample (z); and
providing (19) a final result (y_{final}) of the initiated local and/or remote inference in accordance with a fifth inference function (F_{G}, 25).
